(19) United States
(12) Patent Application Publication
(10) Pub. No.: US 2009/0145009 A1
(43) Pub. Date: Jun. 11, 2009

(54) Package For Distinguishing Beverage Containers

(76) Inventor: Cynthia Zinszer Desatoff, Long Beach, CA (US)

Correspondence Address: FISH & ASSOCIATES, PC;ROBERT D. FISH, 2603 Main Street, Suite 1000, Irvine, CA, 92614-6232, US

(21) Appl. No.: 12/274,043

(22) Filed: Nov. 19, 2008

Related U.S. Application Data
(60) Provisional application No. 61/012,522, filed on Dec. 10, 2007.

(51) Int. Cl. G09F 3/04; B43K 29/00

(52) U.S. Cl. 40/306; 401/193

(57) ABSTRACT

A package for use in distinguishing among beverage containers, using elastic bands to wrap around the beverage containers. These bands have a non-fungible difference in at least one of color, texture, and patterning. The package would be supplied with guidance, in the form of textual and/or graphical instructions, for use of the elastic bands to distinguish among the beverage containers.

This application claims priority to provisional application 61/012,522, filed Dec. 10, 2007 incorporated herein in its entirety.

### FIELD OF THE INVENTION

The field of the invention is the area of distinguishing beverage containers.

### BACKGROUND

A common problem in social settings is that people tend to lose track of their coffee cups, soda cans, bottles or other beverage containers.

U.S. Pat. No. 5,339,549 to David tries to resolve the problem with respect to coffee cups by applying identifying rings around the handles of the cups. US 2006/0207132 to Vaughan attacks the problem with respect to soda cans by applying hang tags to the cans. U.S. Pat. No. 5,358,770 to Evans mounts indicia pieces on a track that encircles the cans. US 2004/0128877, Luedde goes on to teach even further complexity, with an elastomeric band having embossed indicia.

The David '549, Groth '144, Evans '770 patents, the Vaughan '132 and Luedde '877 applications, as well as all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

A significant problem with these prior art solutions is that they are likely too complicated for widespread acceptance by the consuming public. U.S. Pat. No. 5,704,144 to Groth teaches a simpler solution, in which a user writes his/her name on an adhesive strip wrapped around a soda can. The problem there, however, is that distinguishing among different strips requires writing on the strips.

What is still needed is a simple way of distinguishing beverage containers, which does not require a user to write on a band or any other device.

### BRIEF DESCRIPTION OF THE DRAWINGS

FIG. 1 shows the use of a writing instrument to write on a band to identify a beverage can.

FIG. 2 shows instructions, i.e. guidance for use of the bands with a beverage can.

FIG. 3 shows a package of distinct elastic bands, with instructions for use and an instrument for writing on the bands.

FIG. 4 shows a band with relaxed circumference of up to 22 cm and an optional trademark as guidance for distinguishing a beverage can.

FIG. 5 shows a band with a non-elastic portion of at least 0.5 cm length.

FIGS. 6 and 7 show alternative packaging designs.

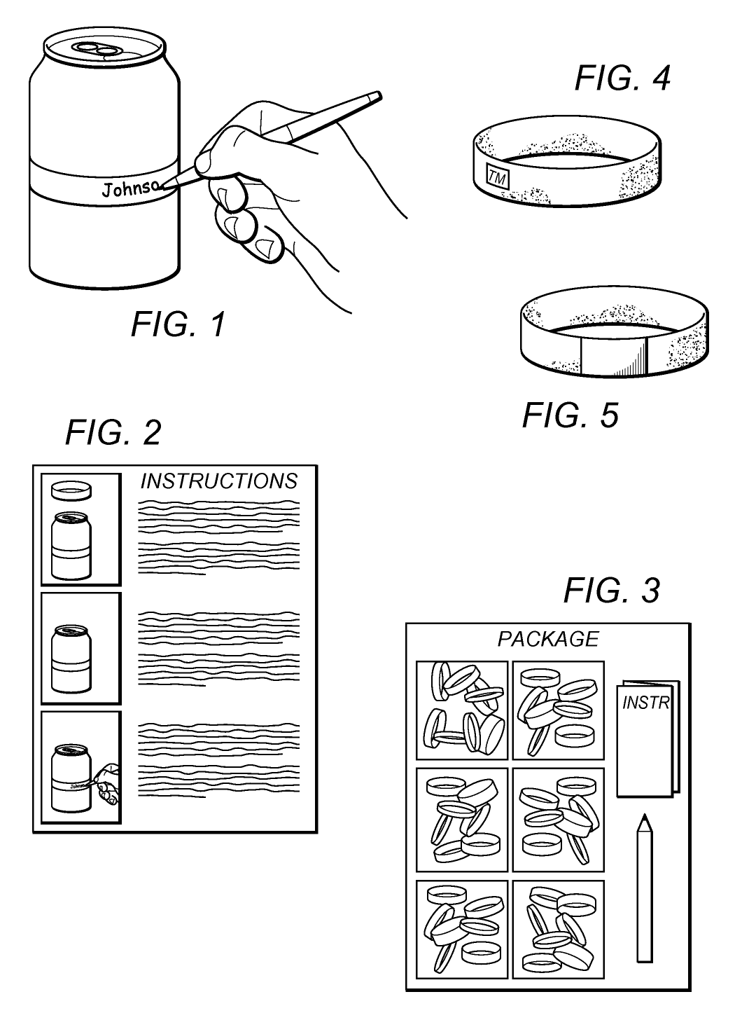

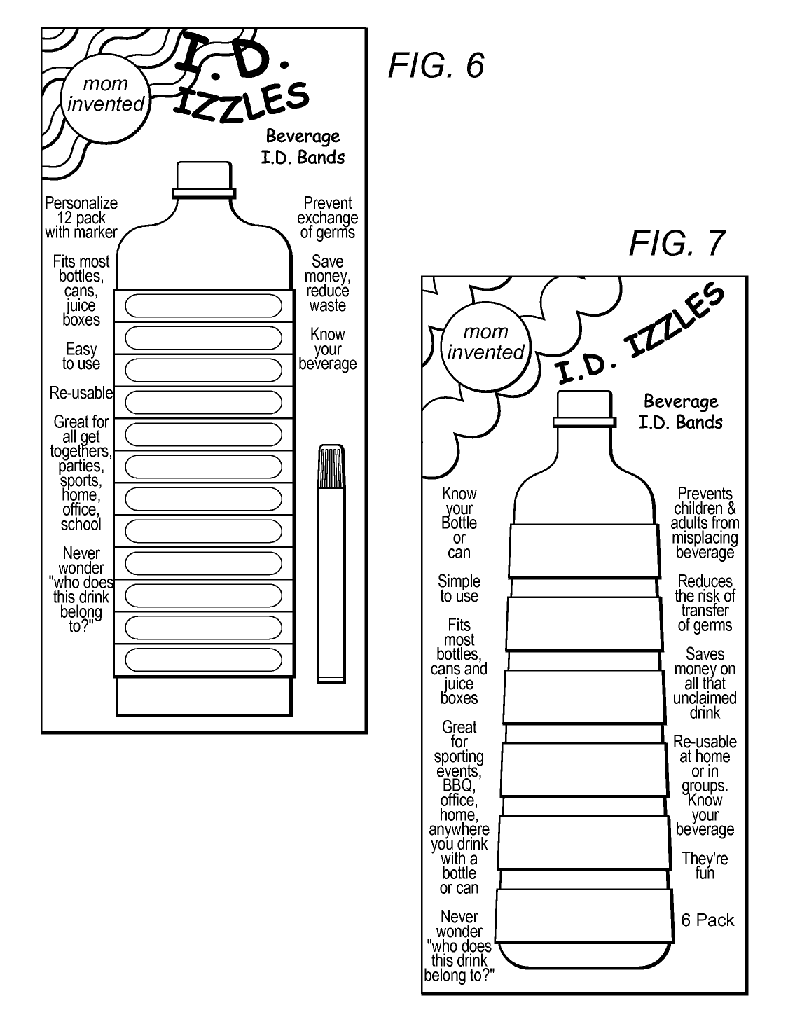

### SUMMARY AND PREFERRED EMBODIMENTS

The present invention provides apparatus, systems and methods in which distinct elastic bands are coupled to, and used to distinguish beverage containers.

In one aspect of preferred embodiments the elastic bands differ according to a desired characteristic or combination of physical characteristics, including for example, color, height, pattern, texture, or edge design. Although the physical characteristics of the bands should be sufficient to distinguish among a set of bands, it is also contemplated that a user could further distinguish the bands by writing a name, number or graphic on one or more of the bands.

Packaging can advantageously comprise a package of non-fungible elastic bands, along with an optional writing instrument capable of inscribing on the bands, and guidance in the form of instructions as to how to customize and/or utilized the bands. As used herein, the term “non-fungible difference” means that the difference is non-trivial with respect to visually distinguishing the items. Contemplated non-fungible characteristics include differences in color, height, texture and patterning.

It is especially contemplated that different ones of the bands in a given package have readily apparent difference, where the term “really apparent” is used to mean that a person can distinguish one band from another with casual observation from a distance of at least 1 meter.

Preferred bands are of a relaxed circumference of no more than 22 cm, which is deemed to be sufficient to fit around a standard soda or beer can. Contemplated bands may optionally include a non-elastic portion, preferable of at least one-half (0.5) cm length, for inscription of indicia.

All suitable forms of guidance are contemplated. For example, the guidance provided for usage of the invention may take the form of textual use instructions, may contain a graphic or drawing to illustrate usage of the bands to distinguish among beverage containers, or any combination of these. Preferred guidance comprises instructions and a series of graphics that show a person writing on the band and/or placing the band on a beverage can.

Thus, specific embodiments and applications of the package for distinguishing between beverage containers have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A package having components for use in distinguishing among at least first and second beverage containers, comprising:
the components including first and second elastic bands having a non-fungible difference in at least one of color, texture, and patterning; and
guidance for writing on the bands, and using the bands to distinguish among the beverage containers.

2. The package of claim 1, further comprising a writing instrument.

3. The package of claim 1, wherein the guidance comprises a trademark that indicates usage of the bands for distinguishing among the beverage containers.

4. The package of claim 2, wherein the guidance comprises textual instructions that indicates usage of the bands for distinguishing among the beverage containers.

5. The package of claim 2, wherein the guidance comprises at least one graphic that collectively indicates usage of the bands for distinguishing among the beverage containers.

6. The package of claim 2, wherein the guidance comprises at least one drawing that collectively indicates usage of the bands for distinguishing among the beverage containers.

7. The package of claim 2, wherein the non-fungible difference comprises a color.

8. The package of claim 2, wherein the non-fungible difference comprises a texture.

9. The package of claim 2, wherein the non-fungible difference comprises a pattern.

10. The package of claim 2, further comprising at least five other bands, each of which has a non-fungible difference from the first and second bands in at least one of color, texture, and patterning.

11. The package of claim 2, f wherein each of the bands has a relaxed circumference of no more than 22 cm.

12. The package of claim 2, wherein the first band is elastic over its entire circumference.

14. The package of claim 2, wherein the first band has a relatively non-elastic portion at least 0.5 cm long.

15. Instructions for using elastic bands to distinguish among beverage containers, comprising,
a reference to at least one of color, texture and patterning differences in at least five elastic bands; and
guidance for using the bands to distinguish among the beverage containers.

16. The instructions of claim 15, wherein the reference includes both text and a graphic.

17. The instructions of claim 15, further comprising guidance for writing on at least one of the bands.

18. A package having the instructions of claim 15, and the first and second elastic bands.
